(19) United States
(12) Patent Application Publication
(10) Pub. No.: US 2025/0149605 A1
(43) Pub. Date: May 8, 2025

(54) LEAK DIAGNOSIS SYSTEM FOR HUMIDIFIER OF FUEL CELL SYSTEM AND CONTROL METHOD THEREOF

(71) Applicants: HYUNDAI MOTOR COMPANY, SEOUL (KR); KIA CORPORATION, SEOUL (KR)

(72) Inventors: Jae Won Jang, Busan (KR); Jong Gyun Kim, Yongin-si (KR); Min Gu Park, Hwaseong-si (KR)

(73) Assignees: HYUNDAI MOTOR COMPANY, SEOUL (KR); KIA CORPORATION, SEOUL (KR)

(21) Appl. No.: 18/668,781

(22) Filed: May 20, 2024

(30) Foreign Application Priority Data
Nov. 8, 2023 (KR) 10-2023-0153621

(51) Int. Cl. H01M 8/04664; G01M 3/40; H01M 8/04111; H01M 8/04119; H01M 8/04223; H01M 8/04537; H01M 8/04746

(52) U.S. Cl. CPC H01M 8/04664; G01M 3/40; H01M 8/04111; H01M 8/04149; H01M 8/04231; H01M 8/04559; H01M 8/04753; H01M 8/04776

(57) ABSTRACT

A leak diagnosis system for a humidifier of a fuel cell system includes a fuel cell stack including a cathode and an anode, an air supply system including at least one of an air compressor, an air cutoff valve, and an air pressure control valve, a hydrogen supply system including at least one of a hydrogen supply valve and a hydrogen purge valve, a humidifier that humidifies air flowing into the cathode, and a controller that maintains airtightness of the cathode, purges hydrogen on a side of the anode, and then releases the airtightness of the cathode to diagnose whether a leak has occurred in the humidifier.

### CROSS REFERENCE TO RELATED APPLICATIONS

The present application claims priority to Korean Patent Application No. 10-2023-0153621, filed Nov. 8, 2023, the entire contents of which is incorporated herein for all purposes by this reference.

### BACKGROUND

### Field

The disclosure relates to a leak diagnosis system for a humidifier of a fuel cell system and a control method thereof.

### Description of the Related Art

A fuel cell system is a power generation system that produces electricity by reacting oxygen in the air with pure silver hydrogen stored in a high-pressure tank. Meanwhile, for proper power generation, the conditions of air flowing in from outside must be controlled, and an air filter may be provided to block foreign substances in the air.

Additionally, the air needs to maintain appropriate humidity in order to produce the power required by a fuel cell stack. Accordingly, the air supply system of the fuel cell system may be provided with a humidifier to control the humidity of the air.

There are a number of hollow fiber membranes inside the humidifier, and if the hollow fiber membrane is disconnected, some of the intake air may pass through the disconnected hollow fiber membrane and be partially exhausted again.

This causes insufficient air flowing into the fuel cell stack, which does not satisfy the required output of the fuel cell stack. As air leakage from the humidifier continues, the voltage deviation of the unit cells constituting the fuel cell stack increases. As a result, there is a problem that the power generation performance of the fuel cell stack may continue to deteriorate.

Conventionally, there was a lack of methods for diagnosing leaks in humidifiers, so in such situations, it was mistakenly recognized as a failure of the fuel cell stack, which could lead to problems with replacing the normal fuel cell stack itself. Further, there is a problem that output defects continue to occur even if the fuel cell stack is replaced.

The information disclosed in this Background section is only for enhancement of understanding of the general background of the disclosure and should not be taken as an acknowledgement that this information forms the prior art already known to a person skilled in the art.

### SUMMARY

The disclosure is proposed to solve the above problem, and is to provide a leak diagnosis system for a humidifier of a fuel cell system and a control method thereof, which can detect air leakage in a humidifier. Thus, when a performance abnormality of a fuel cell stack occurs, air leakage in the humidifier can be checked, and when it is determined that the humidifier is broken, a user can be induced to replace the humidifier by displaying a notification about humidifier replacement and. Further, when necessary, the required output of the fuel cell stack can be temporarily satisfied by driving an air compressor at an increased speed.

According to achieve the above objects, a leak diagnosis system for a humidifier of a fuel cell system according to the disclosure comprises a fuel cell stack including a cathode and a anode, an air supply system including at least one of an air compressor, an air cutoff valve, and an air pressure control valve, a hydrogen supply system including at least one of a hydrogen supply valve and a hydrogen purge valve, a humidifier that humidifies air flowing into the cathode, and a controller that maintains airtightness of the cathode, purges hydrogen on a side of the anode, and then releases the airtightness of the cathode to diagnose whether a leak has occurred in the humidifier.

The controller may maintain the airtightness of the cathode by closing the air cutoff valve and closing the air pressure control valve.

The controller may open the hydrogen purge valve to purge the hydrogen on the anode side.

The controller may open the air cutoff valve to release the airtightness of the cathode.

After releasing the airtightness of the cathode, the controller may monitor a cell voltage of the fuel cell stack to diagnose whether the leak has occurred in the humidifier.

The controller may determine that the leak has occurred in the humidifier if a voltage of a unit cell with a minimum voltage among the unit cells constituting the fuel cell stack is less than a preset value.

The controller may determine that the leak has occurred in the humidifier if a cell voltage ratio (RV) of the fuel cell stack is less than a preset value.

The controller may display a notification about the leak in the humidifier when the controller determines that there is the leak in the humidifier.

The controller may drive the air compressor at a higher driving speed than stored data when the controller determines that there is the leak in the humidifier.

After purging the hydrogen, the controller may maintain the airtightness of the cathode for a standby time and then releases the airtightness of the cathode.

Standby time may be time required to generate a lower pressure inside the cathode compared to atmospheric pressure.

In order to achieve the above object, a control method of a leak diagnosis system for a humidifier of a fuel cell system comprises the steps of maintaining airtightness of a cathode by a controller, purging hydrogen at a side of an anode by the controller, diagnosing whether a leak has occurred in a humidifier by the controller by releasing the airtightness of the cathode.

The step of maintaining the airtightness of the cathode may be a step in which the controller closes an air cutoff valve and closes an air pressure control valve to maintain the airtightness of the cathode.

The step of purging the hydrogen at the anode side may be a step in which the controller opens a hydrogen purge valve to purge the hydrogen at the anode side.

In the step of diagnosing whether the leak has occurred in the humidifier, the controller may open an air cutoff valve to release the airtightness of the cathode, and then monitor a cell voltage of the fuel cell stack to diagnose whether the leak has occurred in the humidifier.

In the step of diagnosing whether the leak has occurred in the humidifier, if a voltage of a unit cell with a minimum voltage among the unit cells constituting the fuel cell stack is less than a preset value, or a cell voltage ratio (RV) of the fuel cell stack is less than a preset value, it may be determined that the leak has occurred in the humidifier.

According to a leak diagnosis system for a humidifier of a fuel cell system and a control method thereof, air leakage in a humidifier can be detected. Thus, when a performance abnormality of a fuel cell stack occurs, air leakage in the humidifier can be checked, and when it is determined that the humidifier is broken, a user can be induced to replace the humidifier by displaying a notification about humidifier replacement. Further, when necessary, the required output of the fuel cell stack can be temporarily satisfied by driving an air compressor at an increased speed.

### BRIEF DESCRIPTION OF THE FIGURES

FIG. 1 is a configuration diagram of a leak diagnosis system for a humidifier of a fuel cell system according to an embodiment of the disclosure.

FIG. 2 illustrates an air flow in a normal state of a humidifier of a fuel cell system.

FIG. 3 illustrates an air flow when a hollow fiber membrane of a humidifier of a fuel cell system is disconnected.

FIG. 4 is a flow chart of a control method of a leak diagnosis system for a humidifier for a fuel cell system according to an embodiment of the disclosure.

FIG. 5 is the mechanism by which reverse voltage is generated inside the fuel cell by an electrochemical reaction when hydrogen and oxygen coexist in the air flowing into the cathode.

### DETAILED DESCRIPTION

Hereinafter, embodiments of the disclosure will be described in detail with reference to the attached drawings. The same or similar components are given the same reference numbers and redundant description thereof is omitted.

In describing the embodiments of the disclosure, if a detailed description of known techniques associated with the disclosure would unnecessarily obscure the gist of the embodiment of the disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

The singular forms are intended to include the plural forms as well, unless the context clearly indicates otherwise.

In addition, in the specification, it will be further understood that the terms “comprise” and “include” specify the presence of stated features, integers, steps, operations, elements, components, or combinations thereof, but do not preclude the presence or addition of one or more other features, integers, steps, operations, elements, components, or combinations.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

Herein, a controller may include a communication device configured to communicate with other controllers or sensors, a memory configured to store operating systems, logic commands, input and output information, etc., and one or more processors configured to perform determination, calculation, judgement, etc. necessary to control a function assigned to the controller so as to control the function.

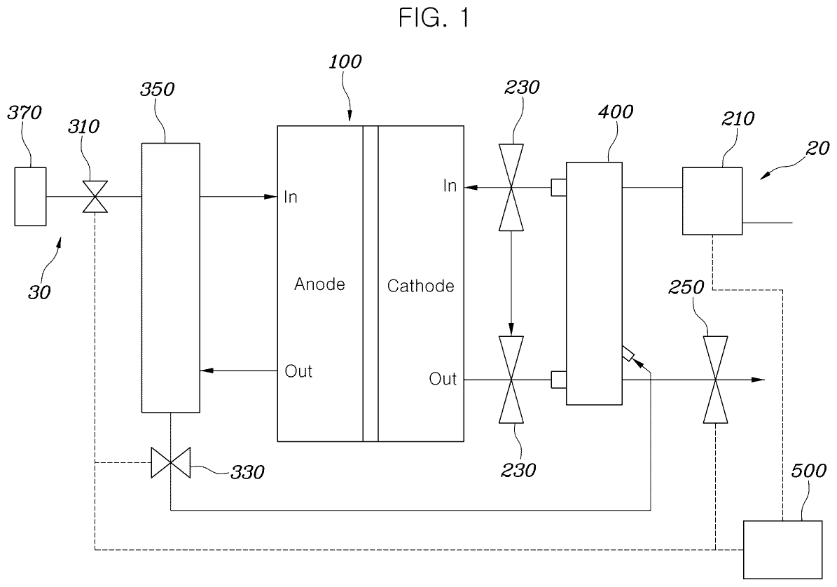

FIG. 1 is a configuration diagram of a leak diagnosis system for a humidifier of a fuel cell system according to an embodiment of the disclosure. Referring to FIG. 1, a leak diagnosis system for a humidifier of a fuel cell system according to an embodiment of the disclosure includes a fuel cell stack 100 including a cathode and an anode, an air supply system 20 that supplies air to each cathode, and a hydrogen supply system 30 that supplies hydrogen to the anode.

The air supply system 20 transmits pressurized air to the cathode by driving the air compressor 210. The pressurized air passes through the humidifier 400, is humidified, and flows into the cathode through the air cutoff valve 230 provided in front of the cathode. The air flowing into the cathode reacts with some of the hydrogen, and some of the air pass through the air cutoff valve 230, the humidifier 400, and the air pressure control valve 250 before being exhausted to the outside.

The hydrogen supply system 30 includes a hydrogen supply valve 310 for introducing high-purity hydrogen supplied from a high-pressure hydrogen storage tank 370 into the anode, an ejector 350 through which hydrogen passing through the anode is recirculated, and a hydrogen purge valve 330 for purging hydrogen through the air supply system 20. Some of the hydrogen that has passed through the anode is recirculated through the ejector 350 and flows into the anode. When the hydrogen concentration falls below a certain level, some of the hydrogen is purged.

When purging hydrogen, the hydrogen purge valve 330 is opened, an air compressor 210 is driven, and an air shut-off valve 230 is closed to generate an air flow that bypasses the cathode, allowing high purity hydrogen to be purged through the air supply system 20.

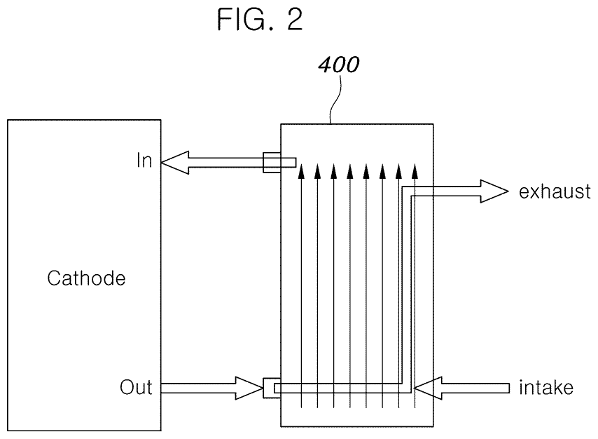

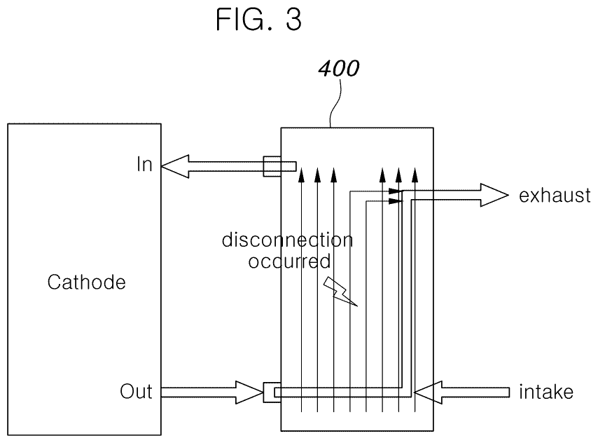

Meanwhile, FIG. 2 illustrates an air flow in a normal state of a humidifier of a fuel cell system, and FIG. 3 illustrates an air flow when a hollow fiber membrane of a humidifier of a fuel cell system is disconnected.

When the humidifier 400 is in a normal state, the intake air and the exhausted air do not mix with each other, but when the hollow fiber membrane of the humidifier 400 is disconnected, some of the intake air is directly exhausted without passing through the cathode, as shown in FIG. 3. Alternatively, some of the exhausted air may not be exhausted to the outside and may be re-inhaled and pass through the cathode.

Because disconnection of the hollow fiber membrane of the humidifier 400 causes a problem of not being able to satisfy the required output of the fuel cell stack 100, it is important to detect an abnormal state of the humidifier 400.

Accordingly, in the disclosure, in order to determine air leakage due to disconnection of the hollow fiber membrane of the humidifier 400, hydrogen on the anode side is purged, and a leak in the humidifier 400 is diagnosed by determining whether the purged hydrogen is sucked into the cathode through the humidifier 400.

Specifically, when diagnosing a leak in the humidifier 400, the controller 500 closes the air cutoff valve 230 and air pressure control valve 250 to maintain airtightness of the cathode. In this case, the hydrogen supply valve 310 is open to allow hydrogen to flow into the anode.

Meanwhile, it is desirable that the airtightness of the cathode is maintained for a standby time. In other words, after the standby time, the airtightness of the cathode may be released. Maintaining the airtightness of the cathode for the standby time is to wait for the remaining hydrogen and air in the fuel cell stack 100 to be consumed by an electrochemical reaction, thereby forming the same pressure at the anode and cathode.

In addition, maintaining the airtightness of the cathode for the standby time is to remove hydrogen that has crossed over to the cathode before confirming that hydrogen due to leakage from the humidifier 400 flows into the cathode. In addition, this is to generate a negative pressure inside the cathode compared to atmospheric pressure so that purged hydrogen can easily flow in through the air cutoff valve 230 when the airtightness of the cathode is released.

Meanwhile, when the air flow flowing into the cathode is blocked, the controller 500 opens the hydrogen purge valve 330 to perform hydrogen purge on the anode side. The purged hydrogen moves toward the humidifier by a natural flow, and if a leak occurs in the humidifier 400, some of the purged hydrogen may be sucked into the cathode through the humidifier 400.

After performing the hydrogen purge, the controller 500 opens the air cutoff valve 230 to release the airtight state of the cathode.

If a leak occurs in the humidifier 400, some of the purged hydrogen is mixed with air pressurized by the air compressor 210 and flows into the cathode.

If a leak has not occurred in the humidifier 400, all of the purged hydrogen may pass through the humidifier 400 and be exhausted to the outside.

The controller 500 may monitor the cell voltage of the fuel cell stack 100 and diagnose whether a leak has occurred in the humidifier 400 according to the monitoring results.

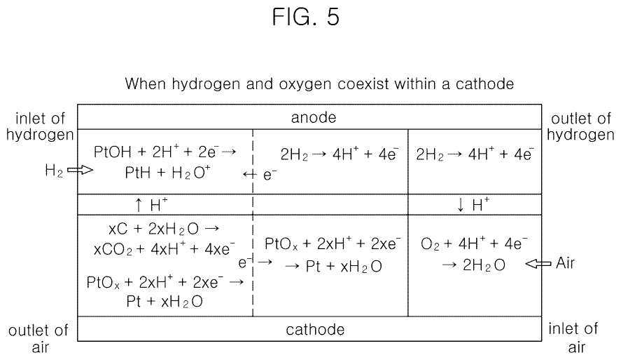

Specifically, when hydrogen and oxygen coexist in the air flowing into the cathode, a reverse voltage is generated inside the cells of the fuel cell due to an electrochemical reaction. The mechanism is as follows in FIG. 5.

This causes situations such as poor cell voltage ratio of the fuel cell stack 100 and inability to generate voltage in some cells of the fuel cell stack 100. Thus, the controller 500 may determine that there is a leak in the humidifier 400 if the voltage of a unit cell with a minimum voltage among the unit cells constituting the fuel cell stack 100 is less than a preset value or a cell voltage ratio (RV) of the fuel cell stack 100 is less than a preset value.

If the controller 500 determines that there is a leak in the humidifier 400, the controller 500 may display a notification about the leak in the humidifier 400 to guide the user to have the humidifier 400 serviced. Additionally, if the controller 500 determines that there is a leak in the humidifier 400, the controller 500 may drive the air compressor 210 at a higher driving speed than stored data.

In other words, due to a leak in the humidifier 400, the air flow rate or pressure to satisfy the required output of the fuel cell stack 100 must be higher than the air flow rate or pressure at the time when the humidifier 400 is normal. Thus, when it is determined that a leak has occurred in the humidifier 400, the air compressor 210 can be driven at a higher speed.

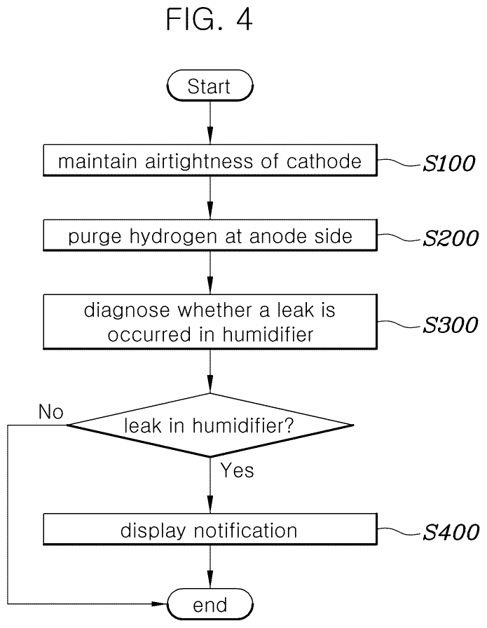

FIG. 4 is a flow chart of a control method of a leak diagnosis system for a humidifier of a fuel cell system according to an embodiment of the disclosure. A method for controlling a leak diagnosis system for a humidifier of a fuel cell system according to the disclosure comprises the steps of maintaining airtightness of the cathode by the controller 500 at S100, purging hydrogen at the anode side by the controller 500 at S200, and diagnosing whether a leak has occurred in the humidifier 500 by the controller 500 by releasing airtightness of the cathode at S300. A notification is displayed at S400.

The step of maintaining the airtightness of the cathode (S100) may be a step in which the controller 500 closes the air cutoff valve 230 and air pressure control valve 250 to maintain the airtightness of the cathode.

The step of purging the hydrogen at the anode side (S200) may be a step in which the controller 500 opens the hydrogen purge valve 330 to purge the hydrogen at the anode side.

In the step (S300) of diagnosing whether a leak has occurred in the humidifier, the controller 500 may open the air cutoff valve 230 to release the airtightness of the cathode, and then monitor the cell voltage of the fuel cell stack 100 to diagnose whether a leak has occurred in the humidifier 400.

In the step (S300) of diagnosing whether a leak has occurred in the humidifier 400, if the voltage of the unit cell with the minimum voltage among the unit cells constituting the fuel cell stack 100 is less than a preset value, or the cell voltage ratio (RV) of the fuel cell stack 100 is less than a preset value, it may be determined that the a leak has occurred in the humidifier 400.

Although a specific embodiment of the disclosure has been described for illustrative purposes, those skilled in the art will appreciate that various modifications and changes are possible, without departing from the scope and spirit of the disclosure as disclosed in the accompanying claims.

1. A leak diagnosis system for a humidifier of a fuel cell system, comprising:
a fuel cell stack including a cathode and an anode;
an air supply system including at least one of an air compressor, an air cutoff valve, and an air pressure control valve;
a hydrogen supply system including at least one of a hydrogen supply valve and a hydrogen purge valve;
a humidifier configured to humidify air flowing into the cathode; and
a controller configured to maintain airtightness of the cathode, to purge hydrogen on a side of the anode, and to release the airtightness of the cathode to diagnose whether a leak occurs in the humidifier.

2. The leak diagnosis system of claim 1, wherein the controller is configured to maintain the airtightness of the cathode by closing the air cutoff valve and closing the air pressure control valve.

3. The leak diagnosis system of claim 1, wherein the controller is configured to open the hydrogen purge valve to purge the hydrogen on the anode side.

4. The leak diagnosis system of claim 1, wherein the controller is configured to open the air cutoff valve to release the airtightness of the cathode.

5. The leak diagnosis system of claim 1, wherein after releasing the airtightness of the cathode, the controller is configured to monitor a cell voltage of the fuel cell stack to diagnose whether the leak has occurred in the humidifier.

6. The leak diagnosis system of claim 5, wherein the controller determines that the leak has occurred in the humidifier if a voltage of a unit cell with a minimum voltage among the unit cells constituting the fuel cell stack is less than a preset value.

7. The leak diagnosis system of claim 5, wherein the controller determines that the leak has occurred in the humidifier if a cell voltage ratio (RV) of the fuel cell stack is less than a preset value.

8. The leak diagnosis system of claim 1, wherein the controller is configured to display a notification about the leak in the humidifier when the controller determines that there is the leak in the humidifier.

9. The leak diagnosis system of claim 8, wherein the controller is configured to drive the air compressor at a higher driving speed than stored data when the controller determines that there is the leak in the humidifier.

10. The leak diagnosis system of claim 1, wherein after purging the hydrogen, the controller is configured to maintain the airtightness of the cathode for a standby time, and then to release the airtightness of the cathode.

11. The leak diagnosis system of claim 10, wherein the standby time is a time required to generate a lower pressure inside the cathode compared to atmospheric pressure.

12. A control method of a leak diagnosis system for a humidifier of a fuel cell system, the method comprising:
maintaining airtightness of a cathode by a controller;
purging hydrogen at a side of an anode by the controller; and
diagnosing whether a leak has occurred in a humidifier by the controller by releasing the airtightness of the cathode.

13. The control method of claim 12, wherein in maintaining the airtightness of the cathode, the controller closes an air cutoff valve and closes an air pressure control valve to maintain the airtightness of the cathode.

14. The control method of claim 12, wherein in purging the hydrogen at the anode side the controller opens a hydrogen purge valve to purge the hydrogen at the anode side.

15. The control method of claim 12, wherein in diagnosing whether the leak has occurred in the humidifier, the controller opens an air cutoff valve to release the airtightness of the cathode, and then monitors a cell voltage of the fuel cell system to diagnose whether the leak has occurred in the humidifier.

16. The control method of claim 15, wherein in diagnosing whether the leak has occurred in the humidifier, if a voltage of a unit cell with a minimum voltage among the unit cells constituting the fuel cell stack is less than a preset value, or a cell voltage ratio (RV) of the fuel cell system is less than a preset value, it is determined that the leak has occurred in the humidifier.
